(19) United States
(12) Patent Application Publication
(10) Pub. No.: US 2023/0115703 A1
(43) Pub. Date: Apr. 13, 2023

(54) ANALYSIS ASSISTANCE DEVICE, ANALYSIS ASSISTANCE METHOD AND NON-TRANSITORY COMPUTER READABLE MEDIUM STORING ANALYSIS ASSISTANCE PROGRAM

(71) Applicant: SHIMADZU CORPORATION, Kyoto (JP)

(72) Inventor: Tomohiro KAWASE, Kyoto (JP)

(21) Appl. No.: 17/947,104

(22) Filed: Sep. 17, 2022

(30) Foreign Application Priority Data
Oct. 7, 2021 (JP) 2021-165735

(51) Int. Cl. G01N 30/86

(52) U.S. Cl. CPC G01N 30/8675; G01N 30/8651; G01N 2030/027

(57) ABSTRACT

An analysis assistance device includes an estimator that estimates a distribution of measurement quality indicator data using a regression analysis by using a plurality of analysis condition data pieces provided to an analysis device and a plurality of measurement data pieces obtained by the analysis device based on the plurality of analysis condition data pieces, an analysis assistance information displayer that displays the distribution on a display, and a saver that saves an analysis condition data piece of a point of interest designated in the distribution in a storage device in response to a saving operation.

### BACKGROUND

### Technical Field

The present invention relates to an analysis assistance device, an analysis assistance method and an analysis assistance program for handling measurement data obtained by an analysis device, and a non-transitory computer readable medium storing the analysis assistance program.

### Description of Related Art

In pharmaceutical companies and so on, substances are analyzed with use of a liquid chromatograph. In this case, it is required to develop a method with which as many peaks as possible are resolved in order to separately confirm a subject substance and impurities. Development of a method is carried out by acquisition of a result of analysis with respect to various analysis conditions. With the data processing device disclosed in JP 2015-166726 A, it is possible to easily acquire analysis conditions that have not yet been considered. Although all combinations of various analysis conditions are to be considered in the development of a method, it is impossible to perform an analysis using all combinations. Thus, a regression analysis may be performed.

### SUMMARY

A user can consider an optimal analysis condition by displaying a result of a regression analysis as contour lines or a heat map, for example. Further, it is desirable to provide the user with a function for effectively utilizing the result of the regression analysis.

An object of the present invention is to provide a function that enables effective utilization of a result of a regression analysis.

An analysis assistance device according to one aspect of the present invention includes an estimator that estimates a distribution of measurement quality indicator data using a regression analysis by using a plurality of analysis condition data pieces provided to an analysis device and a plurality of measurement data pieces obtained by the analysis device based on the plurality of analysis condition data pieces, an analysis assistance information displayer that displays the distribution on a display, and a saver that saves an analysis condition data piece of a point of interest designated in the distribution in a storage device in response to a saving operation.

An analysis assistance method according to another aspect of the present invention includes estimating a distribution of measurement quality indicator data using a regression analysis by using a plurality of analysis condition data pieces provided to an analysis device and a plurality of measurement data pieces obtained by the analysis device based on the plurality of analysis condition data pieces, displaying the distribution of measurement quality indicator data on a display, and saving an analysis condition data piece of a point of interest designated in the distribution in a storage device in response to a saving operation.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is an overview of an analysis system according to the present embodiment;

FIG. 2 is a diagram showing the configuration of a computer according to the present embodiment;

FIG. 3 is a block diagram showing the functions of the computer according to the present embodiment;

FIG. 4 is a flowchart showing an analysis assistance method according to an embodiment; and

FIG. 5 is a diagram showing an analysis assistance screen according to the embodiment.

### DETAILED DESCRIPTION

An analysis assistance device, an analysis assistance method and an analysis assistance program according to embodiments of the present invention will now be described with reference to the attached drawings.

### (1) Overall Configuration of Analysis System

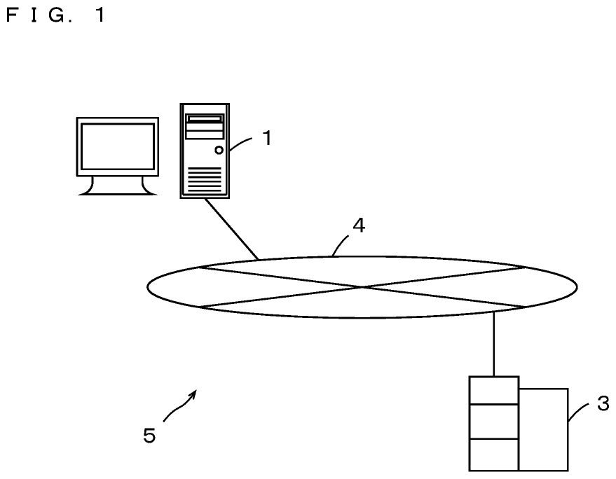

FIG. 1 is an overview of an analysis system 5 according to the present embodiment. The analysis system 5 includes a computer 1 and a liquid chromatograph 3. The computer 1 and the liquid chromatograph 3 are connected to each other through a network 4. The network 4 is a LAN (Local Area Network), for example.

The computer 1 has a function of setting an analysis condition in the liquid chromatograph 3, a function of acquiring a result of measurement in the liquid chromatograph 3 and analyzing the result of measurement and so on. A program for controlling the liquid chromatograph 3 is installed in the computer 1.

The liquid chromatograph 3 includes a pump unit, an autosampler unit, a column oven unit, a detector unit and the like. The liquid chromatograph 3 further includes a system controller. The system controller controls the liquid chromatograph 3 in accordance with a control instruction received from the computer 1 through the network 4. The system controller transmits the data of a result of measurement of the liquid chromatograph 3 to the computer 1 through the network 4.

### (2) Configuration of Computer (Analysis Assistance Device)

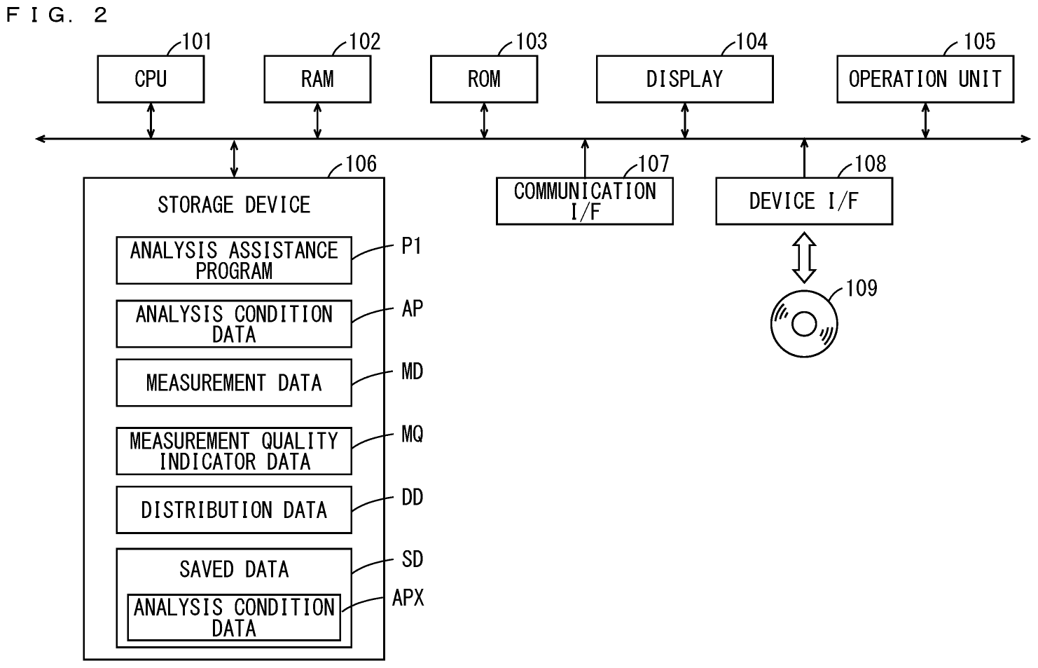

FIG. 2 is a diagram showing the configuration of the computer 1. In the present embodiment, a personal computer is utilized as the computer 1. The computer 1 includes a CPU (Central Processing Unit) 101, a RAM (Random Access Memory) 102, a ROM (Read Only Memory) 103, a display 104, an operation unit 105, a storage device 106, a communication interface 107 and a device interface 108.

The CPU 101 controls the computer 1. The RAM 102 is used as a work area for execution of a program by the CPU 101. A control program and the like are stored in the ROM 103. The display 104 is a liquid crystal display, for example. The operation unit 105 is a device that receives a user operation, and includes a keyboard, a mouse and so on. The display 104 may be constituted by a touch panel display, and the display 104 may have a function as the operation unit 105. The storage device 106 is a device that stores various programs and data. The storage device 106 is a hard disc, for example. The communication interface 107 is an interface that communicates with another computer and another device. The communication interface 107 is connected to the network 4. The device interface 108 is an interface for accessing various external devices. The CPU 101 can access a recording medium 109 via an external device connected to the device interface 108.

The storage device 106 stores an analysis assistance program P1, analysis condition data AP, measurement data MD, measurement quality indicator data MQ, distribution data DD and saved data SD. The analysis assistance program P1 is a program for controlling the liquid chromatograph 3. The analysis assistance program P1 has a function of setting an analysis condition with respect to the liquid chromatograph 3 and a function of acquiring a result of measurement from the liquid chromatograph 3 and analyzing the result of measurement, etc. Analysis condition data AP is the data describing an analysis condition to be set in the liquid chromatograph 3, and includes a plurality of analysis parameters. Measurement data MD is the data of a result of measurement acquired from the liquid chromatograph 3. Measurement quality indicator data MQ is the data for evaluating quality of a result of measurement acquired from the liquid chromatograph 3. Measurement quality indicator data MQ is a minimum resolution or the number of resolved peaks, for example. Distribution data DD is the data representing the distribution of measurement quality indicator data MQ estimated based on analysis condition data AP actually set in the liquid chromatograph 3 and measurement data MD actually measured in the liquid chromatograph 3. Distribution data DD represents a response surface of measurement quality indicator data MQ. Saved data SD is the data in regard to a point APS of interest saved by a user operation.

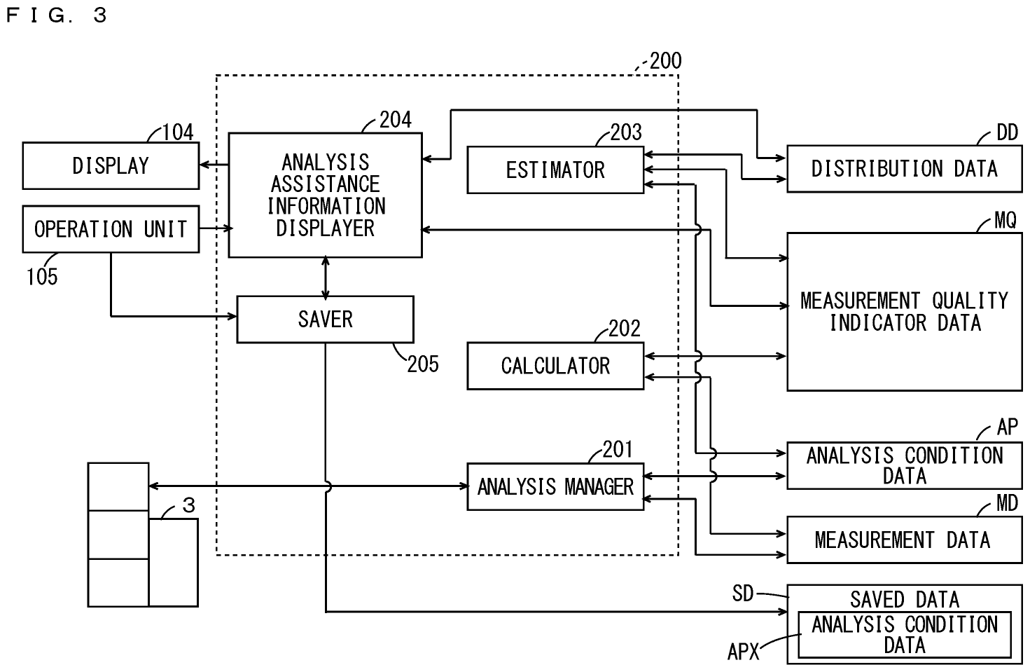

FIG. 3 is a block diagram showing the functions of the computer 1. The controller 200 is a function implemented when the CPU 101 uses the RAM 102 as a work area and executes the analysis assistance program P1. The controller 200 includes an analysis manager 201, a calculator 202, an estimator 203, an analysis assistance information displayer 204 and a saver 205.

The analysis manager 201 controls the liquid chromatograph 3. The analysis manager 201 provides an instruction for executing an analysis process to the liquid chromatograph 3 in response to receiving an instruction for setting of analysis condition data AP and for start of the analysis process from a user. The analysis manager 201 also acquires measurement data MD from the liquid chromatograph 3.

The calculator 202 calculates measurement quality indicator data MQ based on the measurement data MD representing a result of measurement in the liquid chromatograph 3. The calculator 202 calculates a minimum resolution or the number of resolved peaks as the measurement quality indicator data MQ.

The estimator 203 estimates distribution data DD representing the distribution of the measurement quality indicator data MQ based on analysis condition data AP used for actual measurement and the measurement quality indicator data MQ actually calculated based on the analysis condition data AP. The distribution data DD includes an estimated value of the measurement quality indicator data MQ with respect to analysis condition data in regard to which an analysis has not actually been performed. The estimator 203 performs a regression analysis in order to estimate the distribution data DD. Specifically, the estimator 203 acquires a regression equation between a plurality of actually used analysis condition data pieces AP and a plurality of measurement quality indicator data pieces MQ calculated based on actually measured measurement data MD. Then, the estimator 203 applies the regression equation to other analysis condition data pieces that have not been actually used, thereby estimating measurement quality indicator data pieces MQ with respect to the other analysis condition data pieces.

The analysis assistance information displayer 204 displays information for assisting an analysis on the display 104 by using the analysis condition data pieces AP, the measurement quality indicator data pieces MQ estimated by the estimator 203, the distribution data DD and the like. In the present embodiment, the analysis assistance information displayer 204 displays contour lines and a heat map as the distribution data DD. The saver 205 saves analysis condition data APX corresponding to a point APS of interest displayed on an analysis assistance screen 210. Here, although analysis condition data AP represents the data in regard to which an analysis has actually been performed in the liquid chromatograph 3, analysis condition data including the data in regard to which an analysis has not actually been performed is referred to as analysis condition data APX.

A resolution is a value for evaluating the distance between peaks specified in a chromatogram. In the chromatogram, a plurality of peaks corresponding to a plurality of components appear. The smallest value among a plurality of resolutions calculated based on these plurality of peaks can be a measurement quality indicator as a minimum resolution. When a minimum resolution exceeds a predetermined threshold value, it can be determined that a result of measurement in the liquid chromatograph 3 is valid.

The number of resolved peaks is the number of peaks specified in a chromatogram. In a case in which the user identifies the number of substances included in a sample to be measured in advance, the number of resolved peaks can be used as a measurement quality indicator. When the number of resolved peaks exceeds a predetermined threshold value, it can be determined that a result of measurement in the liquid chromatograph 3 is valid.

### (3) Analysis Assistance Method

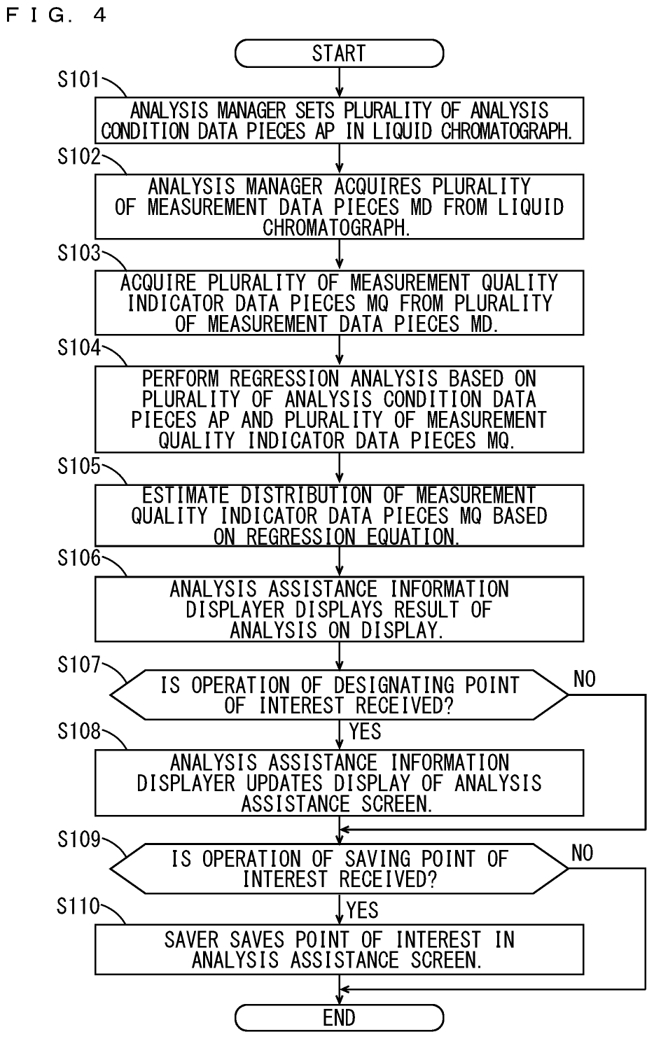

Next, an analysis assistance method performed in the computer 1 (analysis assistance device) according to the present embodiment will be described. FIG. 4 is a flowchart showing the analysis assistance method according to the present embodiment. Before the process shown in FIG. 4 is started, the user operates the operation unit 105 in advance to set a plurality of analysis condition data pieces AP. Specifically, the user sets combinations of setting values of analysis parameters such as a solvent concentration, a solvent mixing ratio, a gradient initial value, a gradient and a column temperature as the analysis condition data pieces AP. For example, combinations of analysis parameters having solvent concentrations being slightly different from one another, combinations of analysis parameters having column temperatures being slightly different from one another, etc. are set as the analysis condition data pieces AP. In response to receiving such a user setting operation, the analysis manager 201 saves the plurality of analysis condition data pieces AP in the storage device 106.

Next, in the step S101 shown in FIG. 4, the analysis manager 201 sets the plurality of analysis condition data pieces AP in the liquid chromatograph 3. Specifically, the analysis manager 201 sets the plurality of analysis condition data pieces AP for a system controller of the liquid chromatograph 3. In response to this, an analysis process is executed multiple times on the same sample based on the plurality of set analysis condition data pieces AP in the liquid chromatograph 3.

Next, in the step S102, the analysis manager 201 acquires a plurality of measurement data pieces MD from the liquid chromatograph 3. The analysis manager 201 saves the plurality of acquired measurement data pieces MD in the storage device 106.

Next, in the step S103, the calculator 202 acquires the plurality of measurement data pieces MD saved in the storage device 106 in the step S102, and acquires a plurality of measurement quality indicator data pieces MQ from the plurality of acquired measurement data pieces MD.

Next, in the step S104, the estimator 203 performs a regression analysis based on the plurality of analysis condition data pieces AP and the plurality of measurement quality indicator data pieces MQ. Thus, the estimator 203 calculates a regression equation between an analysis condition and a measurement quality indicator.

Subsequently, in the step S105, the estimator 203 estimates the distribution of the measurement quality indicator data pieces MQ based on the regression equation. In the present embodiment, Bayesian estimation is used when a regression analysis is performed. Alternatively, a least-squares method can be used for a regression analysis.

The above-mentioned steps S101 to S105 are performed in the computer 1 by the analysis assistance program P1, so that a measurement quality indicator is estimated also in regard to an analysis condition other than an analysis condition in regard to which an analysis has actually been performed. That is, a measurement quality indicator in regard to an analysis condition data piece APX is obtained. Thus, the estimator 203 creates a distribution data piece DD which is a response to a measurement quality indicator. The estimator 203 saves the distribution data piece DD in the storage device 106.

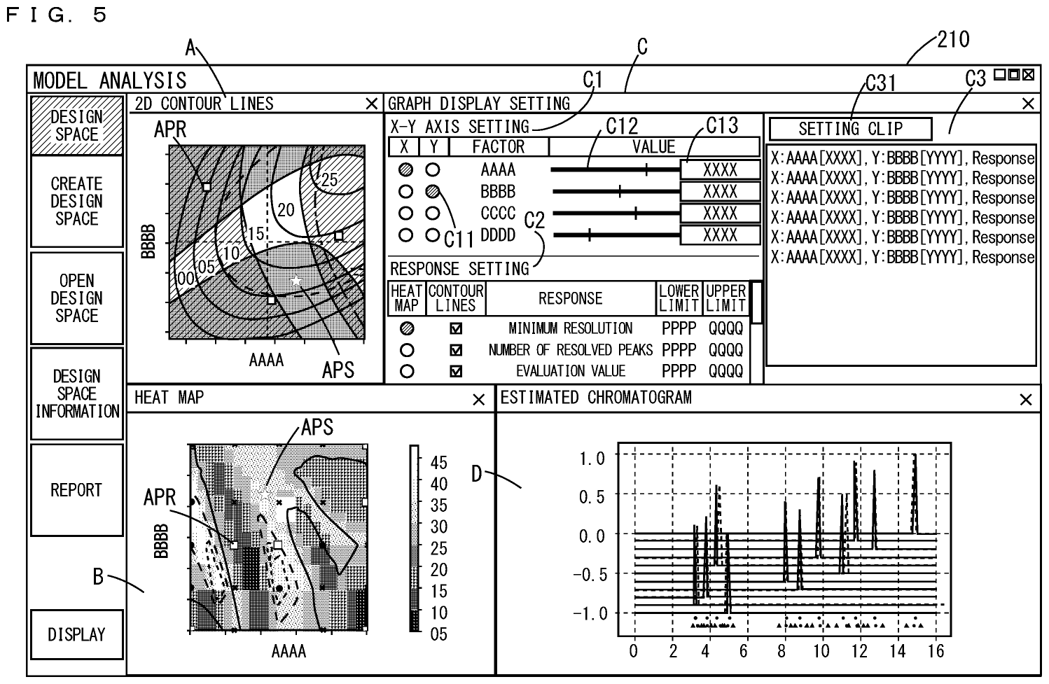

Next, in the step S106, the analysis assistance information displayer 204 displays the information about a result of analysis including a design space on the display 104. FIG. 5 is a diagram showing the analysis assistance screen 210 displayed on the display 104 by the analysis assistance information displayer 204. The analysis assistance screen 210 includes a contour line display area A, a heat map display area B, a graph display setting area C and a chromatogram display area D.

In the contour line display area A, contour lines representing results of analysis are displayed based on the distribution data piece DD. The contour lines are used as a design space. The contour lines represent a contour map of the distribution data piece DD (response surface) drawn with two factors (analysis parameters) as axes.

In the heat map display area B, a heat map representing the results of analysis is displayed based on the distribution data piece DD. The heat map is utilized as a design space. The heat map is a heat map diagram of the distribution data piece DD (response surfaces) drawn with two factors (analysis parameters) as axes.

Actual measurement points APR (white squares in the diagrams) displayed in the contour line display area A and the heat map display area B are points corresponding to the analysis condition data pieces AP in regard to which an analysis has actually been performed in the liquid chromatograph 3. Points APS of interest (stars in the diagrams) displayed in the contour line display area A and the heat map display area B are points corresponding to analysis condition data piece APX selected by the user.

The graph display setting area C is an area in which methods of displaying the contour line display area A and the heat map display area B are set. The graph display setting area C includes an X-Y axis setting portion C1, a response setting portion C2 and a list portion C3. In the X-Y axis setting portion C1, two factors serving as axes for contour lines and a heat map to be displayed in the contour line display area A and the heat map display area B are respectively set. For example, the factors are analysis parameters such as a solvent concentration, a solvent mixing ratio, a gradient initial value, a gradient and a column temperature. In the example of the diagram, a radio button C11 of the X axis is turned ON with respect to a factor AAAA, and a radio button C11 of the Y axis is turned ON with respect to a factor BBBB. The factors AAAA and BBBB are set as two axes for contour lines and a heat map. Although not being set as axes for the contour lines and the heat map, each of factors CCCC and DDDD is one of factors that determine contour lines and a heat map to be displayed.

Values are also set in the X-Y axis setting portion C1. The values indicate the coordinates of the point APS of interest to be displayed in the contour line display area A and the heat map display area B. Therefore, the point APS of interest has an X coordinate and a Y coordinate. In the example of the diagram, the X coordinate corresponds to a value of the factor AAAA, and the Y coordinate corresponds to a value of the factor BBBB. Values are designated by a slide operation with use of a slide bar C12 or an input operation respect to an input unit C13. The user can perform the slide operation using the slide bar C12 or perform the input operation with respect to the input unit C13 by using the operation unit 105.

It is also possible to designate the coordinates of the point APS of interest by selecting coordinates in the contour line display area A and the heat map display area B by using the operation unit 105 (an input device such as a mouse). That is, an operation of selecting the point APS of interest in the contour line display area A and the heat map display area B and an operation of setting the point APS of interest with use of the slide bar C12 or the input unit C13 are interlinked with each other.

In the response setting portion C2, the type of contour lines to be displayed in the contour line display area A and the type of a heat map to be displayed in the heat map display area B are set. In the example of the diagram, a minimum resolution, the number of resolved peaks and an evaluation value are set for contour lines. In this case, in the contour line display area A, the contour lines of a minimum resolution, the number of resolved peaks and an evaluation value are displayed in a superimposed manner. An evaluation value is the overall evaluation value of a minimum resolution and the number of resolved peaks. In the example of the diagram, a minimum resolution is set for a heat map. In this case, the heat map of the minimum resolution is displayed in the heat map display area B. Since heat maps cannot be displayed in a superimposed manner, a plurality of heat maps may be displayed side by side when a plurality of responses are selected.

An upper limit and a lower limit are also set in the response setting portion C2. An upper limit and a lower limit represent a design space (allowable range of an analysis parameter). For example, in regard to contour lines, the region in which the values of a certain response are equal to or larger than a lower limit value and equal to or smaller than an upper limit value is identified and displayed as an allowable range. For example, an allowable range is displayed in a specific color.

In the chromatogram display area D, a chromatogram corresponding to the point APS of interest is displayed. In the chromatogram display area D, a chromatogram may be displayed based on the measurement data piece MD with respect to the analysis condition data piece AP closest to the point APS of interest. Alternatively, a chromatogram in regard to the point APS of interest may be estimated and displayed by Bayesian estimation.

Description returns to the flowchart of FIG. 4. In the step S107, the analysis assistance information displayer 204 determines whether an operation of designating the point APS of interest has been received. As described above, the analysis assistance information displayer 204 receives an operation of designating the point APS of interest when a setting operation with use of the slide bar C12 or the input unit C13 is performed or an operation of selecting coordinates on the contour line display area A and the heat map display area B is performed.

In the step S108, the analysis assistance information displayer 204 performs a process of updating the display of the analysis assistance screen 210 based on the analysis condition data piece APX of the designated point APS of interest. For example, the analysis assistance information displayer 204 changes the position at which the point APS of interest is displayed. Further, the analysis assistance information displayer 204 updates a chromatogram to be displayed in the chromatogram display area D. Alternatively, the display method for the contour line display area A, the heat map display area B and the chromatogram display area D are updated in accordance with the setting contents in the graph display setting area C.

Reference is again made to FIG. 5. In the list portion C3, a list of saved analysis condition data pieces APX is displayed. As described above, it is possible to designate the coordinates of the point APS of interest to be displayed in the contour line display area A and the heat map display area B by operating the operation unit 105. It is possible to save the analysis condition data piece APX corresponding to the point APS of interest by performing an operation of selecting a setting clip button C31 in the list portion C3 with the point APS of interest displayed in the contour line display area A and the heat map display area B. The analysis condition data piece APX corresponding to the point APS of interest is saved in the storage device 106 as saved data SD. The analysis condition data piece APX recorded in the saved data SD includes all factors (analysis parameters) such as the factors CCCC and DDDD as well as the factors (AAAA and BBBB in the example of the diagram) set to be displayed for the X axis and the Y axis. A list of the analysis condition data pieces APX saved by selection of the setting clip button C31 is displayed in the list portion C3.

The display setting information of the analysis assistance screen 210 is also saved in the saved data SD together with the analysis condition data piece APX of the point APS of interest. That is, the information set in the X-Y axis setting portion C1 and the response setting portion C2 is also saved in the saved data SD. Therefore, when the user selects an analysis condition data piece APX listed in the list portion C3, contour lines and a heat map are displayed in accordance with the setting contents of the X-Y axis setting portion C1 and the response setting portion C2.

Description returns to the flowchart of FIG. 4. In the step S109, the saver 205 determines whether an operation of saving a point APS of interest has been received. As described above, the user can perform the operation of saving a point APS of interest by performing the operation of selecting the setting clip button C31 using the operation unit 105. In response to this operation, the saver 205 saves the saved data SD in regard to the point APS of interest in the storage device 106. In the saved data SD, the display setting information of the analysis assistance screen 210 is saved together with the analysis condition data piece APX corresponding to the point APS of interest.

In this manner, with the computer 1 (analysis assistance device) of the present embodiment, the analysis condition data piece APX corresponding to the point APS of interest can be saved in the analysis assistance screen 210. The user can save a plurality of analysis condition data pieces APX as candidates for an optimal analysis condition, for example. Further, according to the present embodiment, the display setting information of the analysis assistance screen 210 is also saved in regard to a plurality of analysis condition data pieces APX. After performing the method scouting while referring to the analysis assistance screen 210, the user can check the analysis assistance screen 210 again with the same display settings in regard to an analysis condition data piece APX saved as a candidate.

### (4) Other Embodiments

In the above-mentioned embodiment, the liquid chromatograph 3 is used an analysis device of the present invention, by way of example. The present invention can also be applied to a gas chromatograph. Further, in the above-described embodiment, the computer 1 serving as the analysis assistance device of the present embodiment is connected to the liquid chromatograph 3 serving as an analysis device through the network 4, by way of example. In another embodiment, the computer 1 may be built in an analysis device.

In the above embodiment, the analysis assistance program P1 is saved in the storage device 106, by way of example. In another embodiment, the analysis assistance program P1 may be saved in the recording medium 109 to be provided. The CPU 101 may access the recording medium 109 through the device interface 108 and save the analysis assistance program P1 saved in the recording medium 109 in the storage device 106 or the ROM 103. Alternatively, the CPU 101 may access the recording medium 109 through the device interface 108 and execute the analysis assistance program P1 saved in the recording medium 109. Alternatively, in a case in which the analysis assistance program P1 is saved in a server on a network, the CPU 101 may download the analysis assistance program P1 through the communication interface 107.

### (5) Aspects

It will be appreciated by those skilled in the art that the exemplary embodiments described above are illustrative of the following aspects.

(Item 1)

An analysis assistance device according to one aspect includes an estimator that estimates a distribution of measurement quality indicator data using a regression analysis by using a plurality of analysis condition data pieces provided to an analysis device and a plurality of measurement data pieces obtained by the analysis device based on the plurality of analysis condition data pieces, an analysis assistance information displayer that displays the distribution on a display, and a saver that saves an analysis condition data piece of a point of interest designated in the distribution in a storage device in response to a saving operation.

It is possible to provide the analysis assistance device that can effectively utilize a result of a regression analysis.

(Item 2)

The analysis assistance device according to item 1, wherein the saver may save analysis condition data pieces of a plurality of points of interest.

It is possible to save a plurality of analysis condition data pieces listed as candidates during the method scouting.

(Item 3)

The analysis assistance device according to item 1 or 2, wherein the saver may save a display setting for the analysis assistance information displayer together with the analysis condition data piece of a point of interest.

It is possible to reproduce a display mode of an analysis assistance screen in regard to a saved analysis condition data piece.

(Item 4)

The analysis assistance device according to any one of items 1 to 3, wherein the saver may cause the display to display a list of the analysis condition data piece of a point of interest saved in the storage device.

It is possible to select a saved analysis condition data piece while referring to the distribution of measurement quality indicator data pieces.

(Item 5)

The analysis assistance device according to any one of items 1 to 4, wherein the distribution may include contour lines of the measurement quality indicator data.

It is possible to save analysis condition data pieces to be candidates while utilizing contour lines as a design space.

(Item 6)

The analysis assistance device according to any one of items 1 to 4, wherein the distribution may include a heat map of the measurement quality indicator data.

It is possible to save analysis condition data pieces to be candidates while utilizing a heat map as a design space.

(Item 7)

An analysis assistance method according to another aspect includes estimating a distribution of measurement quality indicator data using a regression analysis by using a plurality of analysis condition data pieces provided to an analysis device and a plurality of measurement data pieces obtained by the analysis device based on the plurality of analysis condition data pieces, displaying the distribution of measurement quality indicator data on a display, and saving an analysis condition data piece of a point of interest designated in the distribution in a storage device in response to a saving operation.

It is possible to provide the analysis assistance method that enables effective utilization of a result of a regression analysis.

(Item 8)

A non-transitory computer readable medium storing an analysis assistance program according to another aspect for causing a computer to perform an analysis assistance method, wherein the analysis assistance method includes estimating a distribution of measurement quality indicator data using a regression analysis by using a plurality of analysis condition data pieces provided to an analysis device and a plurality of measurement data pieces obtained by the analysis device based on the plurality of analysis condition data pieces, displaying the distribution of measurement quality indicator data on a display, and saving an analysis condition data piece of a point of interest designated in the distribution in a storage device in response to a saving operation.

It is possible to provide the analysis assistance program that enables effective utilization of a regression analysis.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. An analysis assistance device comprising:
an estimator that estimates a distribution of measurement quality indicator data using a regression analysis by using a plurality of analysis condition data pieces provided to an analysis device and a plurality of measurement data pieces obtained by the analysis device based on the plurality of analysis condition data pieces;
an analysis assistance information displayer that displays the distribution on a display; and
a saver that saves an analysis condition data piece of a point of interest designated in the distribution in a storage device in response to a saving operation.

2. The analysis assistance device according to claim 1, wherein
the saver saves analysis condition data pieces of a plurality of points of interest.

3. The analysis assistance device according to claim 1, wherein
the saver saves a display setting for the analysis assistance information displayer together with the analysis condition data piece of a point of interest.

4. The analysis assistance device according to claim 1, wherein
the saver causes the display to display a list of the analysis condition data piece of a point of interest saved in the storage device.

5. The analysis assistance device according to claim 1, wherein
the distribution includes contour lines of the measurement quality indicator data.

6. The analysis assistance device according to claim 1, wherein
the distribution includes a heat map of the measurement quality indicator data.

7. An analysis assistance method including:
estimating a distribution of measurement quality indicator data using a regression analysis by using a plurality of analysis condition data pieces provided to an analysis device and a plurality of measurement data pieces obtained by the analysis device based on the plurality of analysis condition data pieces;
displaying the distribution of measurement quality indicator data on a display; and
saving an analysis condition data piece of a point of interest designated in the distribution in a storage device in response to a saving operation.

8. A non-transitory computer readable medium storing an analysis assistance program for causing a computer to perform an analysis assistance method,
the analysis assistance method including:
estimating a distribution of measurement quality indicator data using a regression analysis by using a plurality of analysis condition data pieces provided to an analysis device and a plurality of measurement data pieces obtained by the analysis device based on the plurality of analysis condition data pieces;
displaying the distribution of measurement quality indicator data on a display; and
saving an analysis condition data piece of a point of interest designated in the distribution in a storage device in response to a saving operation.
